(19) United States
(12) Patent Application Publication
(10) Pub. No.: US 2018/0158063 A1
(43) Pub. Date: Jun. 7, 2018

(54) POINT-OF-SALE FRAUD DETECTION USING VIDEO DATA AND STATISTICAL EVALUATIONS OF HUMAN BEHAVIOR

(71) Applicant: RetailNext, Inc., San Jose, CA (US)

(72) Inventors: Mark Jamtgaard, Mountain View, CA (US); Arun Nair, San Jose, CA (US)

(21) Appl. No.: 15/390,215

(22) Filed: Dec. 23, 2016

Related U.S. Application Data
(60) Provisional application No. 62/430,301, filed on Dec. 5, 2016.

(51) Int. Cl. G06Q 20/40; G06Q 20/20; G06F 17/30

(52) U.S. Cl. CPC G06Q 20/4016; G06F 17/3079; G06Q 20/206

(57) ABSTRACT

A system, method and non-transitory, computer-readable storage medium are disclosed for point-of-sale (POS) fraud detection using, POS transaction data, video data and statistical evaluations of employee behavior. In an embodiment, the POS transaction data, video data and statistical evaluations are used to examine patterns of individual employees of an organization versus metrics across all employees of the organization to identify employees that are most likely to perform a fraudulent transaction.

### CROSS-REFERENCE TO RELATED APPLICATION

This application claims priority to U.S. Provisional Patent Application No. 62/430,301, filed Dec. 5, 2016, the entire contents of which is incorporated herein by reference.

### TECHNICAL FIELD

The subject matter of this disclosure relates generally to point-of-sale (POS) fraud analytic systems.

### BACKGROUND

Employees operating cash registers have numerous opportunities to steal from their employers at a POS by price overrides, refund fraud, void fraud, invoicing scams and the like. To combat employee theft, employers have installed sophisticated video surveillance systems at the POS. These systems often include one or more cameras directed to a virtual zone in front of the checkout counter. The one or more video cameras are configured to record video during a transaction, which is then stored in a database with additional transaction information. The video can be reviewed at a later time by security personnel to determine if a theft or pattern of theft has occurred. For large retail store chains that store thousands of transactions associated with hundreds of employees the amount of data can be massive. Searching through a large database of transaction records to identify employee theft is time consuming and expensive.

### SUMMARY

A system, method and non-transitory, computer-readable storage medium are disclosed for point-of-sale (POS) fraud detection using, POS transaction data, video data and statistical evaluations of human behavior. The POS transaction data, video data and statistical evaluations are used to examine patterns of individual employees of an organization versus metrics across all employees of the organization to identify employees that are most likely to perform a fraudulent transaction.

In an embodiment, a method comprises: obtaining, by a computer, video data associated with a plurality of point-of-sale (POS) transactions; obtaining, by the computer, POS transaction data associated with the plurality of POS transactions, including the identities of employees associated with the POS transactions; obtaining, by the computer, statistical data representing past behaviors of the identified employees; identifying, by the computer, and based on the statistical data, the POS transaction data and the video data, one or more particular employees as possibly participating in fraudulent activity during one or more of the POS transactions; and causing to display, on a display device communicatively coupled to the computer, data identifying the one or more particular employees.

In an embodiment, a system comprises: one or more processors; memory coupled to the one or more processors and operable to store instructions, which, when executed by the one or more processors, causes the one or more processors to perform operations comprising: obtaining video data associated with a plurality of point-of-sale (POS) transactions; obtaining point-of-sale (POS) transaction data associated with the plurality of POS transactions, including the identities of employees associated with the POS transactions; obtaining statistical data representing past behaviors of the identified employees; identifying, based on the statistical data, the POS transaction data and the video data, one or more particular employees as possibly participating in fraudulent activity during one or more of the POS transactions; and causing to display, on a display device, data identifying the one or more particular employees.

### BRIEF DESCRIPTION OF THE DRAWINGS

FIG. 1 illustrates an example POS according to an embodiment.

FIG. 2 is a block diagram of a fraud analytic system, according to an embodiment.

FIG. 3A illustrates a POS database schema that combines transaction data, video data and human behavior statistics, according to an embodiment.

FIG. 3B illustrates a first graphical user interface for a dashboard that displays loss prevention data, according to an embodiment.

FIG. 3C illustrates a second graphical user interface for the dashboard that displays loss prevention data, according to an embodiment

FIG. 4 is a flow diagram of a process of combining video data and statistical data, according to an embodiment.

FIG. 5 is a flow diagram of a search query process for a fraud analytic system, according to an embodiment.

FIG. 6 is a block diagram of a computer architecture for implementing the features and processes described in reference to FIGS. 1-5.

### DETAILED DESCRIPTION

### Example Video Surveillance System

The disclosed embodiments determine a likelihood that an employee of an organization is committing fraud. Determining if any one individual POS transaction is fraudulent is difficult. Furthermore, the job of reviewing each individual POS exception event given a list of tens of thousands of POS exceptions is too burdensome. The disclosed embodiments create a ranked list or graph of employees suspected of fraud. Rather than trying to find one exception in the POS data, the disclosed embodiments instead examine patterns of individual employees versus metrics across all employees. This effectively scores each employee's behavior with respect to known patterns of fraud as calibrated by the entire organization which may include thousands of stores and tens of thousands of employees. In an embodiment, the output of a system is a ranked list of employees that are most suspicious. Reviewing this ranked list or graph is a more manageable task than reviewing in individual POS exceptions.

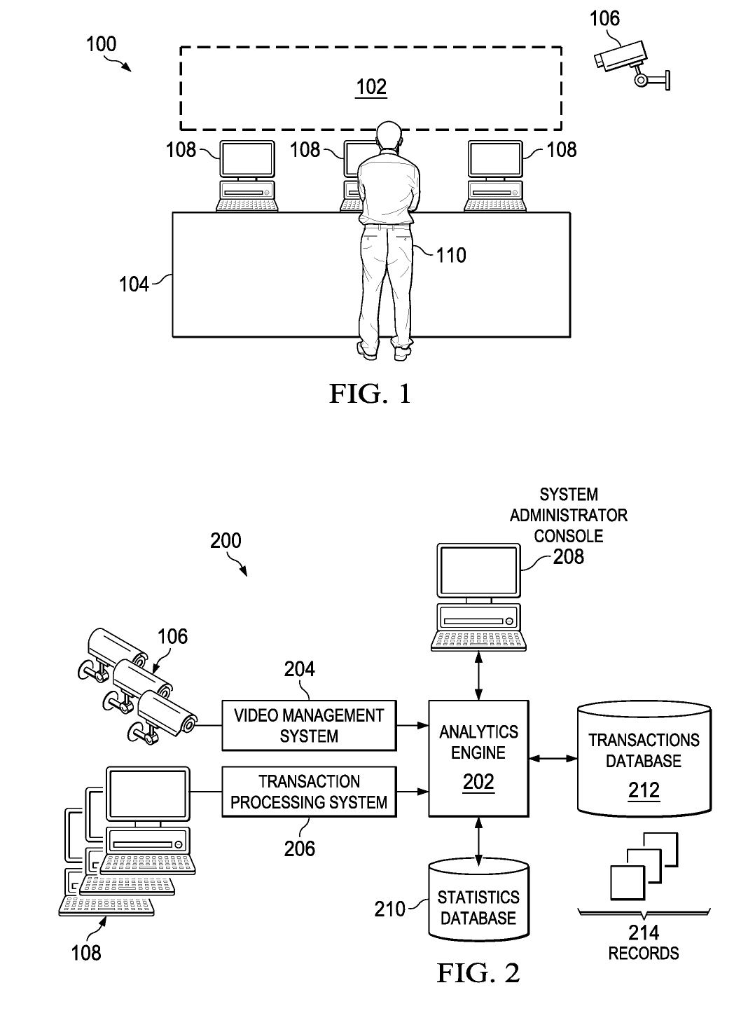

FIG. 1 illustrates a POS 100 according to an embodiment. POS 100 can be located in any indoor or outdoor environment, including but not limited to retail stores, outlets stores, department stores, casinos, banks, restaurants, amusement parks, entertainment venues, movie theatres, service stations, kiosks, ticket counters and the like. Virtual zone 102 is established in the front of check-out counter 104 of a retail store. Virtual zone 102 is used to combat certain types of fraud. For example, when a refund transaction occurs, one would expect a customer to be present in virtual zone 102. If there is no customer present in virtual zone 102 during a refund transaction, the transaction can be flagged otherwise identified as possibly fraudulent. Video camera 106 is directed toward virtual zone 102. Although one video camera is shown, there can be any desired number of video cameras directed to any number of virtual zones, and the video cameras can be mounted at any desired location and pointed in any desired direction to capture one or more views of the POS transaction.

Employee 110 is operating transaction computer 108 (e.g., an electronic cash register). When employee 110 initiates a transaction using transaction computer 108, transaction data is captured and stored in a database, as described in reference to FIG. 2. The transaction data can include any desired information about the transaction, including but not limited to: a transaction identifier (ID), the date/time of the transaction, the store number, name or location, the amount of transaction, the employee's name or employee ID and the transaction type (e.g., sale, refund). Additionally, video data of virtual zone 102 is captured by video camera 106 and stored in the database with the transaction data.

### Example Fraud Analytic System

FIG. 2 is a block diagram of fraud analytic system 200, according to an embodiment. System 200 includes analytics engine 202, video management system 204, transaction management system 206, system administrator console 208, statistics database 210 and transaction database 212. Analytics engine 202 can include software, hardware and a combination of software and hardware. Analytics engine 202 takes as input video data from video management system 202, transaction data from transaction management system 206, statistical data from statistics database 210 and transaction history from transaction database 212. Statistics database 210 stores statistics related to employee behavior during POS transactions. Transaction database 212 stores POS transaction data in transaction records 214. The POS transaction data can include video data, such as video data of virtual zone 102 captured during a transaction at POS 100.

Video management system 203 provides a physical interface for one or more video cameras, such as video camera 106. In an embodiment, video management system 203 includes computer hardware and software that implements people counting/tracking technology, queue management, loitering functionality, crowd detection and remote access.

Transaction processing system 206 provides an interface for various transaction action devices (e.g., cash registers, scanners) and software for implementing a set of policies, procedures designed to facilitate transactions at the POS.

A system administrator can use console 208 to analyze and display data, run search queries and generally facilitate user interaction with analytics engine 202 through a number of graphical user interfaces (GUIs) and input devices. Console 208 can be physically located at the POS and/or located remotely and coupled to analytics engine through a network-based connection (e.g., in Internet or Intranet connection). Console 208 can be any device capable of providing a human interface to analytics engine 202, including but not limited to a desktop computer or mobile device (e.g., a tablet computer, smart phone).

Analytics engine 202 calculates statistical parameters (e.g., averages, medians, variances, standard deviations, quantiles) of various business activities (e.g., POS transactions) to identify patterns in data (e.g., patterns in POS transactions and video data). Analytics engine 202 can generate employee or customer profiles, perform time-series analysis of time-dependent data, perform clustering and classification to discover patterns and associations among groups of data, apply matching algorithms to detect anomalies in the behavior of transactions. The discovered data patterns and associations can be used for a variety of business purposes, including but not limited to improving sales, marketing and customer service. As described herein, the discovered data patterns and associations can also be used to detect certain types of fraud at the POS, such as fraudulent refund transactions, where the employee rings up a cash refund for a customer and then pockets the cash.

In operation, when employee 110 performs a refund transaction using transaction computer 108, video camera 106 captures a video of virtual zone 102. In this example scenario, there is no customer present in virtual zone 102. Video management system 204 receives the video data from video camera 106 and formats the video data so that it can be processed by analytics engine 202. Transaction processing system 206 receives transaction data from transaction computer 108 and formats the transaction data so that it can be processed by analytics engine 202. In this example, statistical data associated with employee 110 is obtained from statistical data database 210 and the video data are placed into record 214 in transaction action database 212. The statistical data can be updated by the transaction data before being placed into record 214.

In an embodiment, analytics engine 202 can maintain a rolling average of refund transactions for each employee including employee 110. For example, assume Employee A has 100 total transactions, 5 of which were refund transactions. Employee A would have an average of 0.05, or 5% of her transactions were refund transactions. Employee B has 100 total transactions, 8 of which were refund transactions. Employee B would have an average of 0.08, or 8% of her transactions were refund transactions. Employee C has 100 total transactions, 1 of which was refund transactions. Employee C would have an average of 0.01, or 1% of her transactions were refund transactions. Employee D has 100 total transactions, 15 of which were refund transactions. Employee D would have an average of 0.15, or 15% of her transactions were refund transactions. From this example, it is clear that Employee D has a much larger percentage of refund transactions than Employees A-C. This information can be stored in statistics database 210 and used by analytics engine 202 to assist system administrators (e.g., through console 208) in focusing on particular records 214 to analyze for fraudulent activity related to refund transactions. Analytics engine 202 can use this statistical data to sort a search result, such as cluster records 214 for Employee D at the top of a search result that is responsive to a search query on refund transactions. In an embodiment, records 214 of Employee D can be augmented with visual indicia (e.g., highlighting, color, badges, background glowing, animation, shading, text) to indicate priority for review. For example, the records for refund transactions for Employee D can be highlighted on a display on console 108 to facilitate review of video clips for each transaction to see if a customer was present in virtual zone 102 during the transaction. In an embodiment, charts and graphs can be presented on the employee to assist the reviewer.

In an embodiment, a baseline value can be used to determine if a particular employee behavior has deviated from the norm. For example, a normal distribution (Gaussian distribution) characterized by a mean and standard deviation can be used to determine an outlier employee for a particular transaction type. In this case, the mean computed from all of the refund transactions of all or a subset of all employees over a specified period of time would be the baseline value. The standard deviation can then be calculated to measure the variability within the normal distribution. Once the distribution is defined mathematically, a norm score can be calculated for each of the employees. The norm scores express the distance of each employee from the mean in terms of standard deviations. Employees with norm scores that are a specified number of standard deviations above the mean (e.g., 2 standard deviations) can be flagged for prioritized review by analytics engine 202.

The mean x̅ can be calculated using Equation [1]:

$$\overline{x} = \frac{{\sum }_{1}^{n} x}{n} , \qquad [ 1 ]$$

and the standard deviation σ is calculated using Equation [2]:

$$σ = \sqrt{\frac{{\sum }_{1}^{n} {\vert x - \overline{x} \vert}^{2}}{n}} . \qquad [ 2 ]$$

Assuming that there are 6 employees (n=6) with refund transaction totals x=(6, 2, 3, 8, 1, 4), then x̅=4 and σ=2.6. Any employee that has refund transactions that exceed 2 standard deviation (2σ) or x>5.2, can be flagged for prioritized review by analytics engine 202. For example, if an employee has 6 refund transactions over the same time period that the sample was taken, then that employee's transaction records would be flagged for prioritized review. Although the example above assumes a normal distribution any distribution or statistical parameter can be used to identify human behavior that is outside of the norm, including for example a median, variance, quantile, etc.

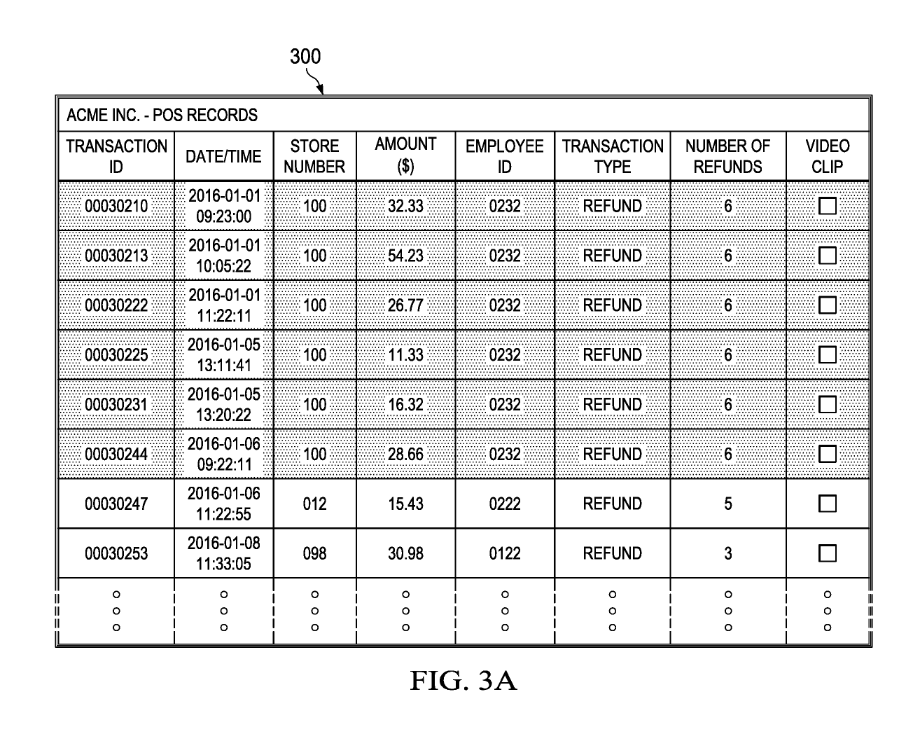

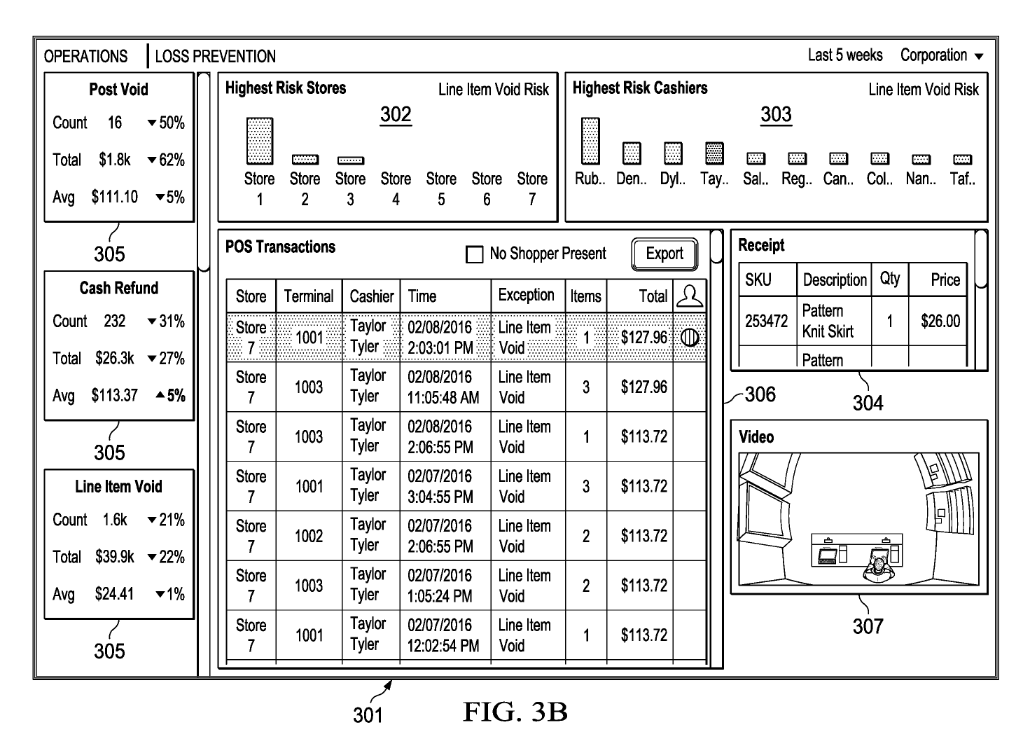

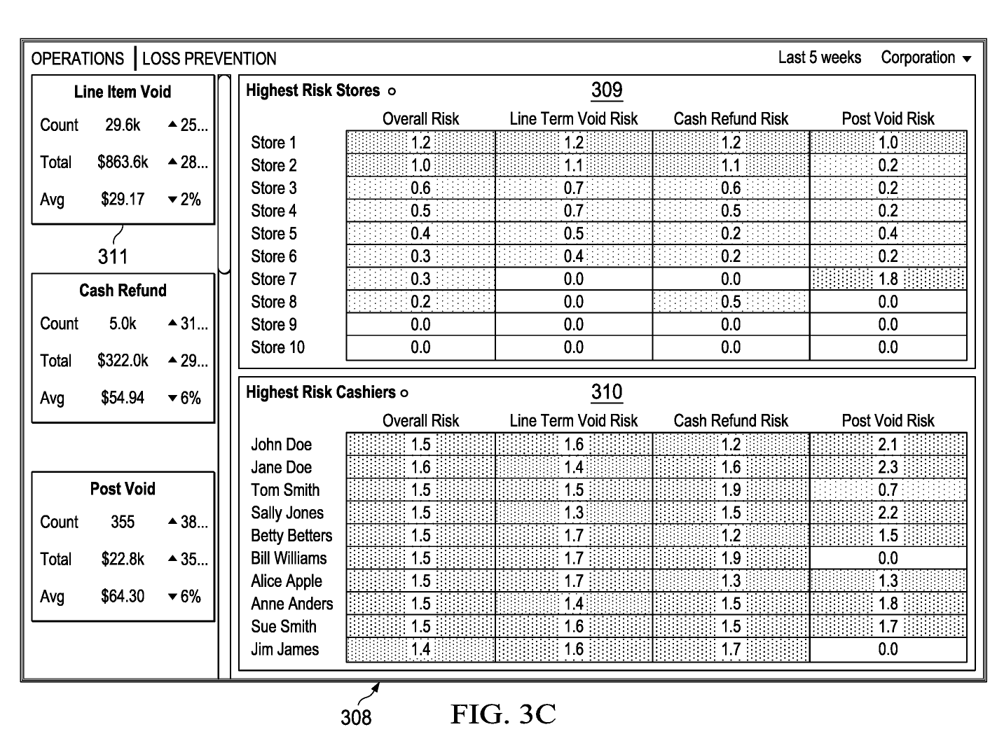

FIG. 3A illustrates a POS database schema that combines transaction data, video data and human behavior statistics, according to an embodiment. In the example shown, 8 POS transaction records are illustrated for the fictitious company ACME INC. in response to a search query for refund records by, for example, a system administrator using console 208. In the example shown, each column represents data and each row is a record. The data includes Transaction ID, Date/Time, Store#, Amount, Employee ID, Transaction Type, #of Refunds, mean (M), standard deviation (σ), >2σ and Video Clip. This example database schema assumes a mean of 4 and a standard deviation of 2.6, which was calculated in the example of the preceding paragraph. In this example, the records were sorted so that the 6 refund transaction records for Employee #0232 are at the top of the search results and highlighted. Because the number of refund transactions for Employee #0232 is greater than 2σ, employee #0232 was flagged by moving his records to the top of the search results and also highlighting the records with shading. The reviewer can click on the video clip icons for each transaction to determine if a customer is present in the virtual zone, as described in reference to FIG. 1.

In an embodiment, analytic engine 202 can process each video clip automatically to determine if a customer is present in the virtual zone. For example, background subtraction/segmentation, or direct detection algorithms can be used to determine the presence of a customer in a video frame. Background subtraction techniques find a foreground object from the video and classify the object as human based on shape, color, motion or other features. Direct techniques operate on features extracted from video patches and classify the features by shape (in the form of contours or other descriptors), color (skin color detection), motion or combinations of these.

FIG. 3B illustrates a first graphical user interface (GUI) for a dashboard that displays loss prevention data, according to an embodiment. In the example shown, GUI 301 includes bar graphs 302, 303 showing the highest risk stores and the highest risk cashiers for Line Item Void risk, where a cashier rings an item and then deletes the item prior to tender. Although vertical bar graphs are shown, any other suitable graph can be used, such as horizontal bars, a pie chart and the like. The risk for stores and cashiers can be determined using the methods described in reference to FIG. 3A. In graph 302, there is a separate vertical bar for each store, where the higher the bar the more risk for Line Item Void risk for the corresponding store. In graph 303, there is separate vertical bar for each cashier, where the higher the bar the more risk for Line Item Void by the corresponding cashier.

GUI 301 further includes POS exception navigator 305 for allowing the user to select a particular POS exception for detailed review, including Post Void (a transaction which cancels, or deletes entirely, a previously completed transaction), Cash Refund and Line Item Void. In other embodiment, any number and type of POS exceptions could also be included in or accessed using POS exception navigator 305. Note that in this example, the system administrator selected the Line Item Void exception from POS exception navigator 305, resulting in bar graphs 302, 303 for Line Item Void to be displayed. Selecting other POS exceptions, such as Cash Refund would cause bar graphs 302, 303 to display the statistics corresponding to Cash Refund. In some embodiment, statistics and other detailed information for two or more transaction exceptions can be displayed simultaneously in GUI 301. In the example shown, for each POS exception various statistics are displayed including: total transaction count, total dollar amount involved in the transaction and an average dollar amount per transaction.

GUI 301 further includes scrollable transaction window 306, which provides pertinent information for each transaction for the POS exception selected by the user from POS exception navigation 305. Window 306 includes a table where each entry or row represents a single transaction. In this example, the columns of the table include but are not limited to: store name, terminal number, cashier name, time, exception, number of items and total dollar amount associated with the exception. Additionally, a line (e.g., a virtual button) is included in each transaction entry, which when selected by the system administrator causes video window 307 to display a video snippet of the selected transaction. In some embodiments, detailed receipt information 304 can be displayed for the selected transaction.

FIG. 3C illustrates a second GUI 308 for the dashboard that displays loss prevention data, according to an embodiment. In the example shown, GUI 308 includes a first table 309 showing the highest risk stores for three POS exception types (Line Item Void, Cashier Refund and Post Void), and the total risk for all three exceptions. GUI 308 also includes a second table 310 for showing the highest risk cashiers for the three POS exception types.

### Example Process Flows

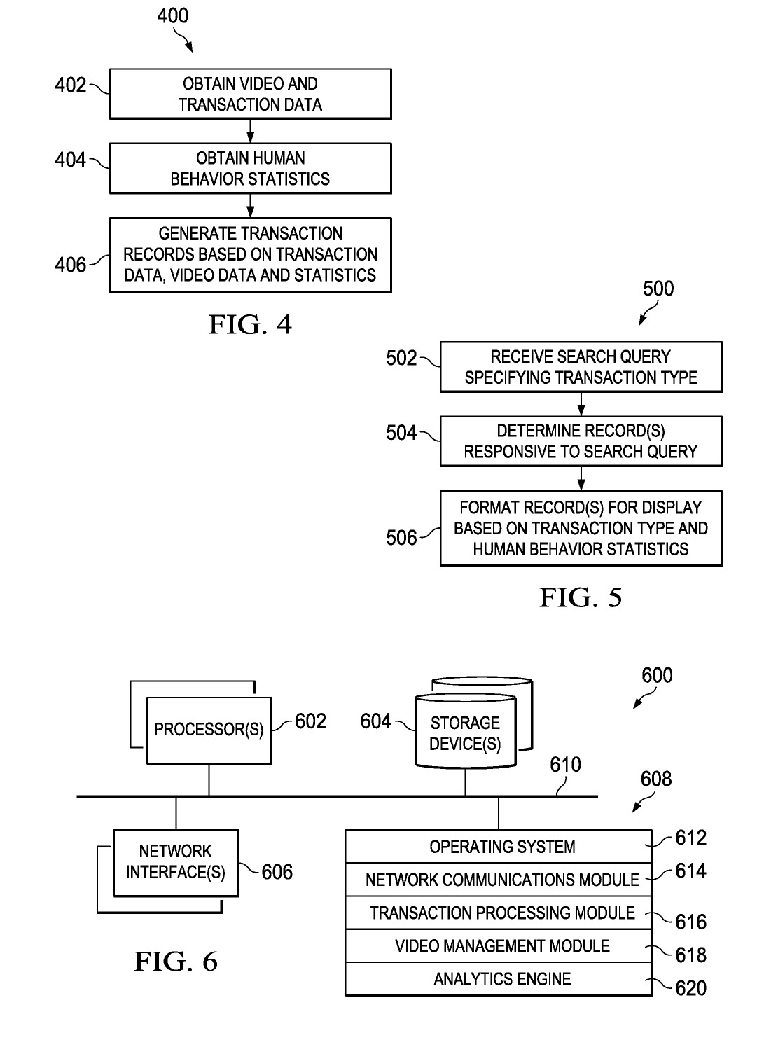

FIG. 4 is a flow diagram of a process of combining video data and statistical data, according to an embodiment. Process 400 can be implemented using the computer architecture 600 described in reference to FIG. 6.

In an embodiment, process 400 can begin by obtaining video and transaction data at a POS (402). For example, a video camera can be mounted to the ceiling or a wall behind a checkout counter in a retail store. The video camera can be pointed towards a virtual zone in front of the checkout counter and can be activated each time a transaction is performed by an employee using a transaction computer, as described in reference to FIG. 1. The transaction data and video data can be stored in a transactions database where it can be accessed by a system administrator using an administrator counsel, a described in reference to FIG. 2.

Process 400 can continue by obtaining human behavior statistics (404). For example, transaction data can be processed by an analytics engine to determine which employees are statistical outliers for certain types of transactions, such as refund transactions. Employees that deviate from a norm can be identified and flagged for prioritized review.

Process 400 can continue by generating transaction records based on the transaction data and the statistics (406). For example, in response to a search query for a certain type of transaction, the records for the transaction type are flagged for prioritized review and presented on a display of a system administrator console with visual indicia to indicate the priority. In an embodiment, the transaction records are sorted so that the transaction records for a particular employee cluster together in the search results to facilitate review by the system administrator. Any type of visual indicia can be used to indicate to the system administrator that the flagged records are presented for prioritized review. In an embodiment, records can be flagged for prioritized review by associating a transaction ID with a priority code, flag, tag or other data in a transaction database that can be used by a search engine to respond to a search query.

FIG. 5 is a flow diagram of a search query process 500 for a fraud analytic system, according to an embodiment. Process 500 can be implemented by computer architecture 600 as described in reference to FIG. 6.

In an embodiment, process 500 can begin by receiving a search query specifying a transaction type (502). For example, a system administrator can search for refund transactions by submitting an appropriate search query specifying refund transactions. Process 500 can continue by determining record(s) responsive to the query (504) and formatting the record(s) for display based on the transaction type and human behavior statistics (506). For example, records in the search for outlier employees can be sorted so that they are clustered at the top of the search results and also augmented with visual indicia.

### Example Computer Architecture

FIG. 6 is a block diagram of example server architecture for implementing the features and processes described in reference to FIGS. 1-5, according to an embodiment. Other architectures are possible, including architectures with more or fewer components. In some implementations, architecture 600 includes one or more processor(s) 602 (e.g., dual-core Intel® Xeon® Processors), one or more network interface(s) 606, one or more storage device(s) 604 (e.g., hard disk, optical disk, flash memory) and one or more computer-readable medium(s) 608 (e.g., hard disk, optical disk, flash memory, etc.). These components can exchange communications and data over one or more communication channel(s) 610 (e.g., buses), which can utilize various hardware and software for facilitating the transfer of data and control signals between components.

The term “computer-readable medium” refers to any medium that participates in providing instructions to processor(s) 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium(s) 608 can further include operating system 612 (e.g., Mac OS® server, Windows® NT server), network communication module 614, transaction processing module 616, video management system 618 and analytics engine 620. Operating system 612 can be multi-user, multiprocessing, multitasking, multithreading, real time, etc. Operating system 612 performs basic tasks, including but not limited to: recognizing input from and providing output to devices 602, 604, 606 and 608; keeping track and managing files and directories on computer-readable medium(s) 608 (e.g., memory or a storage device); controlling peripheral devices; and managing traffic on the one or more communication channel(s) 610. Network communications module 614 includes various components for establishing and maintaining network connections (e.g., software for implementing communication protocols, such as TCP/IP, HTTP, etc.). Transaction processing module 616, video management system 618 and analytics engine 620 are described in reference to FIGS. 1-5.

Architecture 600 can be included in any computer device, including one or more server computers in a local or distributed network each having one or more processing cores. Architecture 600 can be implemented in a parallel processing or peer-to-peer infrastructure or on a single device with one or more processors. Software can include multiple software components or can be a single body of code.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining, by a computer, video data associated with a plurality of point-of-sale (POS) transactions;
obtaining, by the computer, POS transaction data associated with the plurality of POS transactions, including the identities of employees associated with the POS transactions;
obtaining, by the computer, statistical data representing past behaviors of the identified employees;
identifying, by the computer, and based on the statistical data, the POS transaction data and the video data, one or more particular employees as possibly participating in fraudulent activity during one or more of the POS transactions; and
causing to display, on a display device communicatively coupled to the computer, data identifying the one or more particular employees.

2. The method of claim 1, further comprising:
causing to display, on the display device, the data with one or more visual indicia.

3. The method of claim 1, further comprising:
causing to display, on the display device, the video data.

4. The method of claim 3, wherein the video data includes video of a virtual zone at the POS.

5. The method of claim 4, further comprising:
determining, by the computer from the video data, if a customer is occupying the virtual zone.

6. The method of claim 1, further comprising:
determining, by the computer, a baseline value associated with a POS transaction type; and
determining, by the computer, using the baseline value, the one or more particular employees based on the baseline value.

7. The method of claim 6, wherein the baseline value is a mean or average associated with the POS transaction type performed by all or a subset of all the employees.

8. The method of claim 6, wherein the POS transaction type is a refund transaction.

9. The method of claim 1, further comprising:
receiving, by the computer, a search query, the search query including a POS transaction type;
searching, by the computer, a database coupled to the computer, the database storing POS transaction records and the video data;
determining, by the computer from the POS transaction type, the one or more particular employees; and
responding to the search query with one or more POS transaction records associated with the one or more particular employees.

10. A system comprising:
one or more processors;
memory coupled to the one or more processors and operable to store instructions, which, when executed by the one or more processors, causes the one or more processors to perform operations comprising:
obtaining video data associated with a plurality of point-of-sale (POS) transactions;
obtaining point-of-sale (POS) transaction data associated with the plurality of POS transactions, including the identities of employees associated with the POS transactions;
obtaining statistical data representing past behaviors of the identified employees;
identifying, based on the statistical data, the POS transaction data and the video data, one or more particular employees as possibly participating in fraudulent activity during one or more of the POS transactions; and
causing to display, on a display device, data identifying the one or more particular employees.

11. The system of claim 10, further comprising:
causing to display, on the display device, the data with one or more visual indicia.

12. The system of claim 10, further comprising:
causing to display, on the display device, the video data.

13. The system of claim 12, wherein the video data includes video of a virtual zone at the POS.

14. The system of claim 13, further comprising:
determining, from the video data, if a customer is occupying the virtual zone.

15. The system of claim 10, further comprising:
determining a baseline value associated with a POS transaction type; and
determining, using the baseline value, the one or more particular employees based on the baseline value.

16. The system of claim 15, wherein the baseline value is a mean or average associated with the POS transaction type performed by all or a subset of all the employees.

17. The system of claim 15, wherein the POS transaction type is a refund transaction.

18. The system of claim 10, further comprising:
receiving a search query, the search query including a POS transaction type;
searching a database storing POS transaction records and the video data;
determining, from the POS transaction type, the one or more particular employees; and
responding to the search query with one or more POS transaction records associated with the one or more particular employees.

19. A non-transitory, computer-readable storage medium having instructions stored thereon, which, when executed by one or more processors, causes the one or more processors to perform operations comprising:
obtaining video data associated with a plurality of point-of-sale (POS) transactions;
obtaining point-of-sale (POS) transaction data associated with the plurality of POS transactions, including the identities of employees associated with the POS transactions;
obtaining statistical data representing past behaviors of the identified employees;
identifying, based on the statistical data, the POS transaction data and the video data, one or more particular employees as possibly participating in fraudulent activity during one or more of the POS transactions; and
causing to display, on a display device, data identifying the one or more particular employees.

20. The non-transitory, computer-readable storage medium of claim 19, where the operations further comprise:
receiving a search query, the search query including a POS transaction type;
searching a database storing POS transaction records and the video data;
determining, from the POS transaction type, the one or more particular employees; and
responding to the search query with one or more POS transaction records associated with the one or more particular employees.
